(19) United States
(12) Patent Application Publication
(10) Pub. No.: US 2012/0233109 A1
(43) Pub. Date: Sep. 13, 2012

(54) USE OF ASSOCIATIVE MEMORY TO PREDICT MISSION OUTCOMES AND EVENTS

(75) Inventors: Jeffrey E. Hanneman, Kirkland, WA (US); Brian Warn, Seattle, WA (US); Leonard J. Quadracci, Seattle, WA (US)

(73) Assignee: THE BOEING COMPANY, Chicago, IL (US)

(21) Appl. No.: 13/473,568

(22) Filed: May 16, 2012

Related U.S. Application Data
(63) Continuation-in-part of application No. 13/274,310, filed on Oct. 15, 2011.
Application No. 13/274,310 is a continuation-in-part of application No. 11/763,353, filed on Jun. 14, 2007.

(51) Int. Cl. G06N 5/02

(52) U.S. Cl. 706/50

(57) ABSTRACT

A set of mission attributes is identified, and a computer is used to apply Autoassociative Memory to a plurality of patterns to predict at least one of a mission outcome and a future event that, given the set of mission attributes, might occur during execution of a mission.

This is a continuation-in-part of copending U.S. Ser. No. 13/274,310 filed 15 Oct. 2011, which is a continuation-in-part of copending U.S. Ser. No. 11/763,353 filed 14 Jun. 2007.

### BACKGROUND

In the Intelligence Community, intelligence analysts pore through intelligence reports to identify patterns that indicate hostile activities in high threat environments. For instance, the analysts look for buried weapons-employment patterns that show how insurgents are employing weapons and conducting attacks against land forces.

These patterns can be used to predict future hostile activities. For instance, patterns have been used to alert land forces conducting military operation in a region to be concerned about specific types of attacks.

Pattern recognition is daunting for a group of analysts, let alone a single analyst. There could be massive amounts of information to read. The sheer volume can be reduced by having others summarize the information. However, the summaries might omit important pieces of information.

Pattern recognition involves creating mental associations from different pieces of information. The ability to create mental associations varies from analyst to analyst. Analysts may rely on a combination of personal knowledge, and skill and talent to identify patterns. Some analysts might see patterns where others don't. Some analysts might retain more mental associations than others. Yet even an experienced analyst can't retain all mental associations.

Past experience is also important, but it too varies among analysts. An experienced analyst might be able to identify unimportant information and discard it. An experienced analyst might be aware of key historical lessons and apply those lessons.

Where a team of analysts is involved, communicating and coordinating information between the analysts can be difficult. The communication and coordination is especially difficult where hundreds or thousands of analysts are involved.

It would be desirable to improve the manner in which hostile events are predicted. It would also be desirable to present hostile event predictions to front line forces in a timely manner.

### SUMMARY

According to an embodiment herein, a method comprises identifying a set of mission attributes, and using a computer to apply Autoassociative Memory to a plurality of patterns to predict at least one of a mission outcome and a future hostile event that, given the set of mission attributes, might occur during execution of a mission.

According to another embodiment herein, a method comprises processing historical data to predict at least one of an event and an outcome of a mission in an environment. The processing includes forming a plurality of memory entities including matrices of attributes taken from historical data about the environment. Each matrix corresponds to an instance of an event or outcome, and each matrix correlates the occurrence of different attributes within the instance. The processing further includes applying Heteroassociative Memory to the plurality of memory entities to identify patterns of the attributes.

According to another embodiment herein, a computer system comprises module for applying Autoassociative Memory to a plurality of patterns to predict at least one of a mission outcome and a future event that, given a set of mission attributes, might occur during execution of a mission.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of a method of discovering patterns that identify possible future hostile events and mission outcomes.

FIGS. 2a and 2b are illustrations of examples of a memory entity.

FIG. 3 is an illustration of various formats of historical information.

FIGS. 4a and 4b are illustrations of using Autoassociative Memory during planning and operational phases of a mission.

FIG. 5 is an illustration of a system for providing warnings to front line forces.

FIGS. 6a and 6b are illustrations of examples of alerts displayed by a client device.

FIG. 7 is an illustration of a client device for displaying information about predicted hostile events.

### DETAILED DESCRIPTION

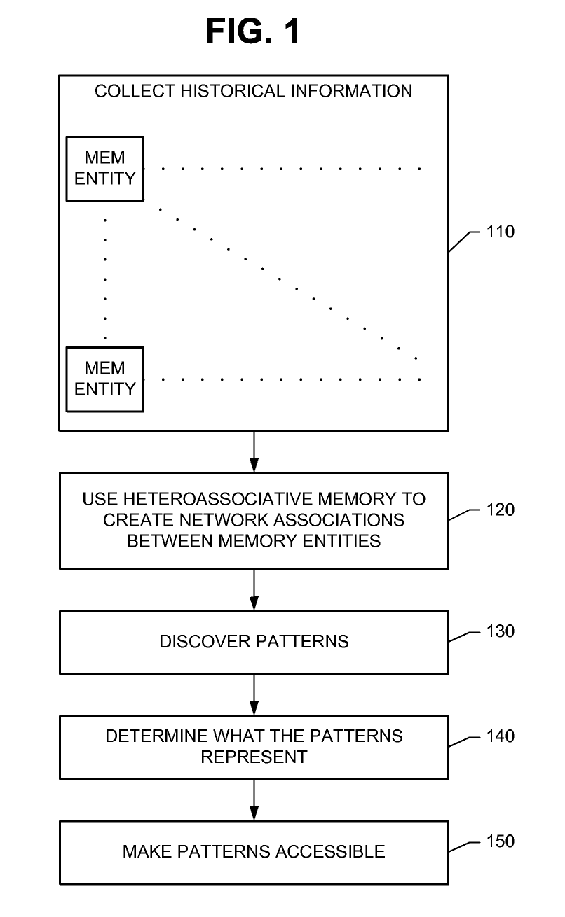

Reference is made to FIG. 1, which illustrates a method of identifying possible future hostile events in high threat environments. The hostile events may be characterized by type of attack. For instance, land forces conducting military operations might be concerned about small arms fire, improvised explosive devices (IED), Rocket Propelled Grenades (RPG) and other types of threats. The land forces might be concerned about attacks occurring at locations such as plots of land, buildings, travel routes of convoys, landing zones, and high traffic areas. The land forces might be concerned about attacks occurring at certain times of day, during certain dates (e.g., anniversaries and holidays), and during certain weather patterns (e.g., dense fog).

At block 110, pieces of historical information are collected from disparate sources. The pieces may include intelligence reports, sensor data, and “lessons learned.” “Prepared” or “structured” intelligence reports may include or originate from, by way of example, observation reports, human intelligence (HUMINT), and electronic intelligence (ELINT). Unprepared or “unstructured” reports may include background briefings, e-mail intercepts, phone text, unedited video material, unedited intelligence reports, and other unedited, unchanged or untreated activity.

Sensor data may include images, such as images obtained from satellite observations. Sensor data may also include acoustic signals, radar tracking, etc.

“Lessons learned” may include key historical lessons. “Lessons learned” may also include feedback (e.g., validation) on previous predictions.

At block 120, the pieces of historical information are ingested. The ingestion includes storing the pieces (e.g., reports) of the historical information as memory entities in computer-readable memory. Each memory entity is categorized according to a category of interest. For example, a memory entity may be categorized as a type of attack, a location, etc.

Each memory entity contains at least one attribute. An attribute may be a numeric value or text string, or it may be a range of values or a range of strings that are “like” a particular string. Examples of attributes for a mission include, but are not limited to,
temporal information (e.g., time, date, holiday).
location information (e.g., latitude and longitude, weather, visibility).
occurrence of a hostile action (e.g., RPG attack).
occurrence of a non-hostile action (e.g., friendly armament, friendly transportation, presence of friendly tanks or other heavy equipment).
lessons learned.
type of source (satellite image, HUMINT).
any other information that was observed.

An attribute may have a specific value or a fuzzy value. A value may be numeric, text, Boolean, etc. Fuzzy values allow attributes to be represented to be consistent with a particular way in which Associative Memory understands and represents data.

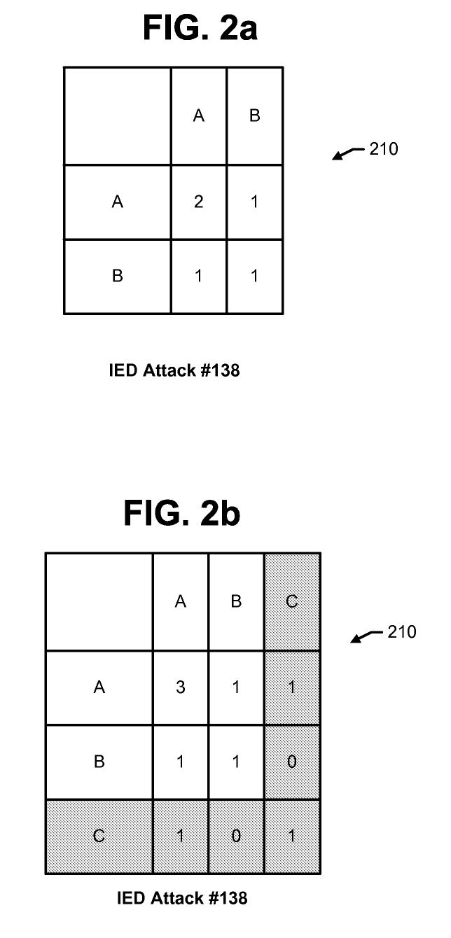

Additional reference is made to FIG. 2a, which illustrates an example a memory entity 210. As used herein, a memory entity is a matrix of attributes. The matrix 210 of FIG. 2a has two attributes: A and B. The matrix correlates the occurrence of each attribute A and B with an instance of an event (e.g., the 138^{th} instance of an IED attack). The matrix 210 also correlates the different attributes with each other. Using the example of FIG. 2a, attribute A is mentioned twice in the different reports of the 138^{th} instance of an IED attack. In one of those reports, both attribute A and attribute B are mentioned.

Reference is now made to FIG. 2b. As new pieces of information are received, new attributes may be added to the memory entity 210 and counts may be updated. In the example of FIG. 2b, attribute C is added to a matrix previously including only attributes A and B. Now attribute A is mentioned three times in the different reports of the 138^{th} instance of an IED attack. In one of those reports mentioning attribute A, attribute B is also mentioned (but not attribute C). In another one of those reports mentioning attribute A, attribute C is also mentioned (but not also attribute B). None of those reports mention attributes B and C in the same report.

FIGS. 2a and 2b illustrate a general property of the matrices: the matrices are symmetrical. Since a matrix is symmetrical, only half of it may be used.

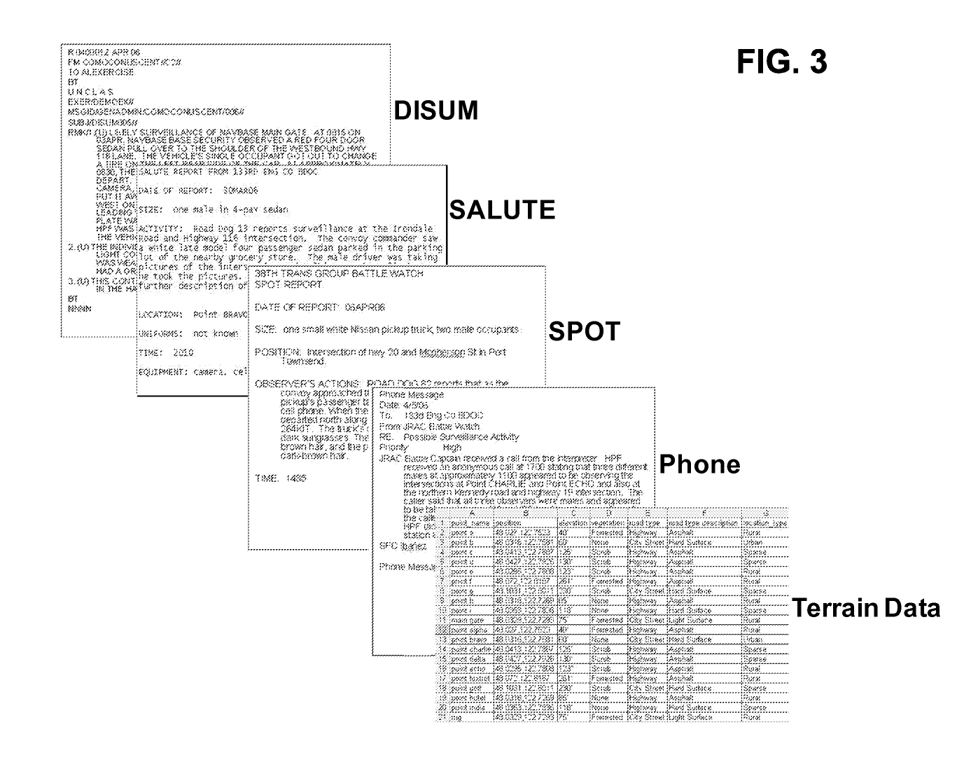

Additional reference is made to FIG. 3, which illustrates examples of pieces of historical information. The pieces illustrated in FIG. 3 include prepared intelligence reports following different formats (DISUM, SALUTE and SPOT). Each format specifies certain fields, which correspond to different attributes. The pieces illustrated in FIG. 3 also include phone calls and terrain data.

To obtain the attributes from a piece of information, the information piece may be parsed. The type of parsing will depend upon the format of a particular piece. As a first example, a regular expression parser may be used to parse information from structured or unstructured documents. Regular expression parsers identify structure of free text by applying rules to patterns of letters and numbers. For instance, the regular expression parser identifies a field and then follows a rule by extracting all text between the field and a period (.). In another instance, the regular expression parses any word having “AK-” followed by two digits, and extracts that word (e.g., AK-47) as a small armament.

As a second example, a semantic or ontology parser may be used to identify common terms in a piece of historical information. For instance, the semantic parser can recognize a name as a type of truck, and a numerical value as the number of occupants in the truck.

Consider the following example of two pieces of historical information. The first piece is an intelligence report about an IED attack. The report includes time, location, and casualties. From that piece, these various attributes are parsed and stored in a memory entity categorized as “IED attack.”

The second piece is an observation about a location. The observation includes latitude, longitude, elevation, vegetation, roads type, road description and location type. The observation also includes temperature and visibility weather at various times of day. The observation also mentions that an IED attack occurred at a given time. In a memory entity categorized by location, the IED attack will be an attribute of the location.

The second piece also identifies a bird observed at the location. This seemingly irrelevant attribute is included in the memory entity. No attempt is made to filter it out. To the contrary, seemingly irrelevant attributes might provide valuable information. For instance, that same bird might be spotted at multiple attack locations. That bird becomes an attribute of the attack. It is a prediction metric: an attack is more likely to occur when that attribute is present.

Reference is once again made to FIG. 1. Over time, large numbers of memory entities will be stored in computer memory.

At block 120, Heteroassociative Memory is used to analyze the number and quality of correlations between attributes of the different memory entities and identify the strength and correlation of attributes of similar entities. Heteroassociative Memory can associate a completely different attribute from those attributes presented as inputs. (In contrast, Autoassociative memory is capable of remembering data by observing a portion of that data.)

The predictive power of the Heteroassociative memory comes from its potential ability to efficiently interpret and analyze the frequency of these co-occurrences and to produce various metrics in real-time. For more information on associative memory, see chapter 4 of Jeff Hawkins et al., “On Intelligence” Henry Holt and Company, ISBN-10: 0805074562.

At block 130, notional rules or patterns are identified from the connections and corresponding weights. For example, the connections between attributes of 1000 memory entities are analyzed, and five distinct patterns are identified. Of those matrices, 70% have strong connections between attributes A, B, and C but not attributes D, E, and F. Therefore, the pattern could be based on the simultaneous presence of attributes A, B and C.

Associative Memory in general may not understand the semantics of the values that it stores. Rather, it may understand them as symbols, and matches the symbols. Thus, at this point, each pattern produced at block 130 is little more than an association of different words. The significance of the patterns have yet to be determined

At block 140, the patterns are then analyzed to determine what they actually represent. For instance, the attributes of one of those patterns might describe an IED attack. Thus, that pattern would be categorized as an IED attack. Or, the pattern might be categorized as a specific type of IED attack, such as an IED attack on a convoy (as opposed to an IED attack on ground forces).

Different types of attacks can be distinguished by differences in the attributes. For instance, an IED attack and a small arms fire attack might share the same group of attributes. However, the IED has several additional attributes. Those additional attributes would distinguish an IED attack from a small arms fire attack.

The patterns may be classified according to mission outcome rather than a type of attack or other type of event. For instance, a pattern is categorized as a success if a convoy reaches its destination without damage. Or it might be categorized as a success if the convoy was hit by an IED, but still reaches its destination with 20% damage. In contrast, the convoy reaching its destination with a high percentage of damage might be classified as a mission failure.

The analysis at block 140 may be performed manually or automatically, or both. For instance, a human analyst may analyze the patterns of attributes and classify the patterns (e.g., IED attack, mission success). Or, a computer may be programmed to cluster those patterns having common attributes.

The method of FIG. 1 can process an abundance of historical information about hostile events, and use Heteroassociative Memory to identify patterns in the historical information. The Heteroassociative Memory can discover new patterns that might not be apparent to an experienced analyst or even a team of analysts. It can establish patterns between attributes that are disjoint or counter-intuitive.

In some instances, patterns may be identified in vast amounts of data about hostile events that occur within a given area of operations, more data than can be processed by an analyst. In other instances, hidden patterns can be revealed even though the historical data is sparse.

A method herein has the flexibility to take advantage of key historical lessons. The historical lessons can be used in various ways. As a first example, they are used to define an initial matrix. Based on past observations, certain attributes are known to occur during an event. An initial matrix can then be created with these known attributes. As additional historical information is gathered, attributes may be added to the initial matrix. In this manner, the historical lessons are used as seeds.

As a second example, historical information is added as attributes to memory entities. For instance, a person on a ridge in the middle of the day is observed. That observation is added to the matrices as an attribute.

Faster processing and pattern recognition times can be achieved by computers than individual analysts or even a team of analysts. Consequently, trend information can be presented quickly to front line forces.

The patterns are updated as new information is collected. The new information might come in the form of new sensor data, which allows new memory entities to be stored in computer memory. Additional associations are created, and new patterns are generated. The new information might come in the form of lessons learned. Historical data can be used to validate existing patterns.

At block 150, the patterns are made accessible to other parties. For example, these patterns may be used to evaluate missions into hostile environments.

A mission may be evaluated during a planning phase and also during an operational phase. The planning phase is performed in advance of a mission. During the planning phase, a plan for the mission is formulated. Attributes are then identified (e.g., weather forecast, departure time, number of units involved). These attributes characterize a profile of the planned mission. The profile is applied to Autoassociative Memory, which, using the patterns generated by the Heteroassociative Memory, predicts an outcome for the mission and/or future hostile events during the mission.

Not all attributes will be known during the planning phase. Some of those attributes can only be ascertained as the mission unfolds. As those additional attributes become available and others are updated, an updated set of attributes may be evaluated by the Autoassociative Memory to predict an updated outcome and/or future hostile events during the mission.

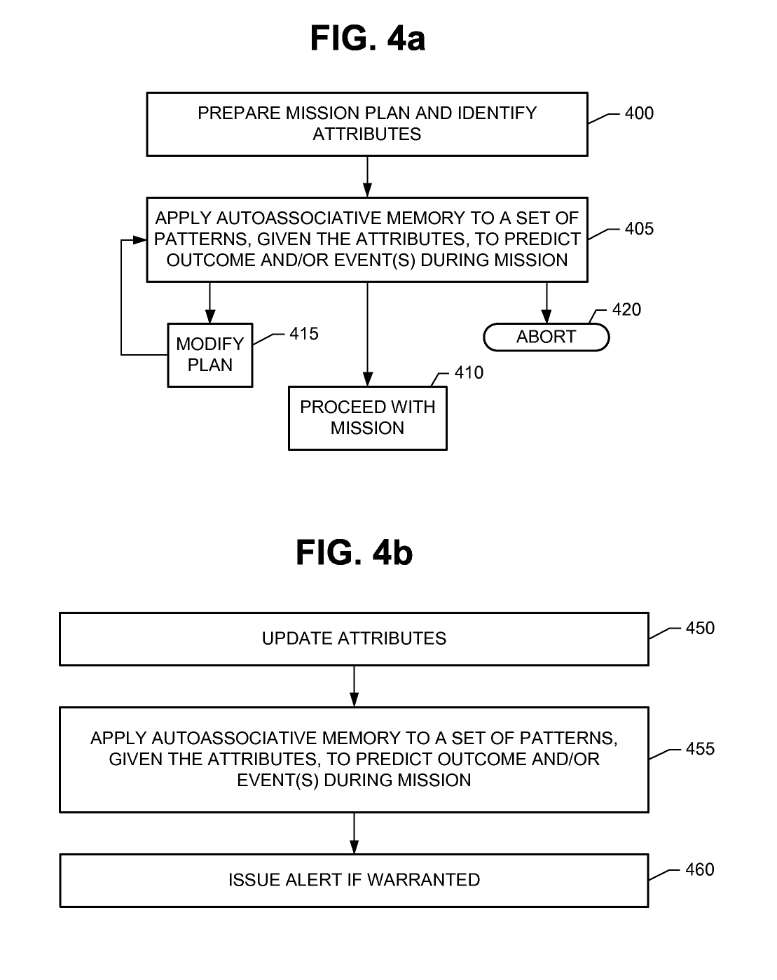

FIGS. 4a and 4b provide some examples of using the patterns during planning and operational phases to present front line forces with real-time predictions of hostile events and outcomes. In these examples, a remote home station communicates with front line forces via network communications.

Reference is made to FIG. 4a, which covers the planning phase. At block 400, a mission plan is formulated. From that plan, a set of attributes is identified.

At block 405, the attribute set is submitted to the home station, which applies Autoassociative Memory to a set of patterns (x1, x2, . . . , xi, xi+1, . . . , xn). Given the set of patterns (x1, x2, . . . , xi, xi+1, . . . , xn), the Autoassociative Memory uses the set of known attributes (x1, x2, . . . , xi) to complete one of the patterns and returns (x1, x2, . . . , xi)+(xi+1, . . . , xn). The pattern returned by the Associative Memory is most likely to occur given the set of known attributes. The returned pattern may give a prediction of the likelihood of the mission succeeding or a prediction of an event that will occur during the mission.

Based on these predictions, a decision may be made to proceed with the mission (block 410) modify it (block 415), or abort it (block 420). A modified mission may be re-evaluated at block 405.

Reference is now made to FIG. 4b, which follows a decision to proceed with a mission. Thus, FIG. 4b covers the operational phase of the mission.

As the mission is carried out, the set of attributes is updated during the mission (block 450). During the mission, additional attributes may be observed, certain attributes may change, etc. For instance, locations may be updated, weather may change, new observations may be made, etc.

The updated attribute set is sent to the home station for evaluation (block 455). The home station applies the Autoassociative Memory to a set of patterns, given the updated attribute set, to predict the likelihood of the mission succeeding or to prediction one or more events that will occur during the mission.

At block 460, a decision is made about issuing an alert. In some embodiments, an alert may be raised if current mission attributes are highly correlated with an enemy attack or land force vulnerability. For instance, if the prediction indicates an 80% likelihood of an attack, or a 60% likelihood of mission failure, an alert may be issued.

The severity of the alert (e.g., red alert, yellow alert) is based, for example, on the number of attributes that are matched, the strength of the correlations and the sparseness of the information.

The functions at blocks 450-460 may be repeated during the mission. In some embodiments, the functions at blocks 450-460 may be performed whenever an attribute changes or a new observation is made. In some embodiments, these functions may be performed periodically. In some embodiments, these functions may be performed upon request. In some embodiments, these functions may be performed if there is a significant drop off in capability. For instance, the functions at blocks 450-460 may be performed whenever communications goes down, equipment fails, etc.

Alerts may be pushed onto front line forces. The home station continually tracks the locations of the front line forces (e.g., the home station queries client devices of front line forces to determine their whereabouts), updates the attributes as the locations change, and sends the updated attributes to the home station for evaluation. The home station may then issue an alert based on those whereabouts.

Alerts may be pulled from the home station. Front line forces use client devices that access current data about a region that the forces are currently occupying or plan to occupy. Attributes representing the current data are supplied to the home station, which generates predictions and returns an alert, if warranted. For instance, a convoy plans to follow a route to a destination. Based on the returned pattern and current location of convoy and other current data, the convoy is alerted to the possibility of hostile events along the route. Changes to aspects of the operation may be made, for example, by increasing number of heavy equipment units in a convoy, avoiding a particular place at a particular time, or changing routes, armament, transport equipment or other operational parameters.

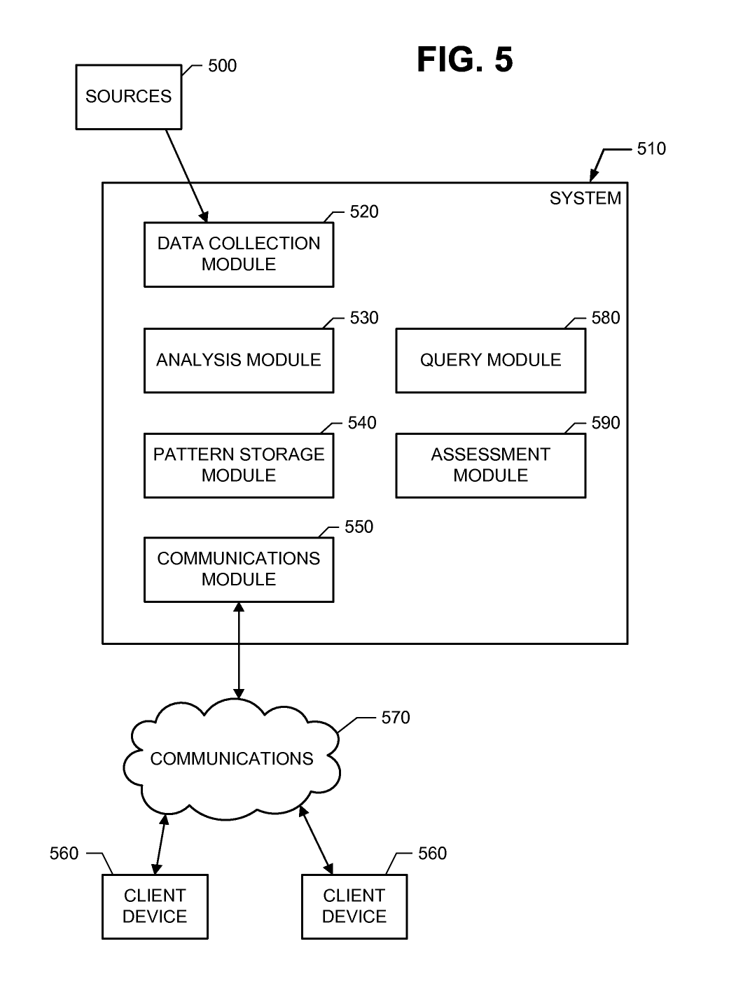

Reference is now made to FIG. 5, which illustrates a system 510 for discovering patterns that identify possible mission outcomes and events and for providing information to front line forces. The system 510 includes hardware and software. The hardware may range from a single laptop computer to a server system to cluster of distributed computers. The software is executed by the hardware. In the following paragraphs, the system 510 will be characterized as a plurality of modules, where each module includes a combination of hardware and software.

A data collection module 520 communicates with various sources 500 to collect intelligence reports and other information about a geographic region of interest. The data collection module 520 stores the reports in computer-readable memory as memory entities.

An analysis module 530 analyzes the memory entities with Heteroassociative Memory to make weighted connections between the attributes of the different memory entities. Commercial Off-the-Shelf (COTS) software is available from Saffron Technology of Morrisville, N.C. For instance, SAFFRON ENTERPRISEOne™ may be configured to identify correlations between attributes of the memory entities and discover patterns from the strength and number of the correlations

The system 510 further includes a means for making the patterns and other information available to front line forces. In the system 510 of FIG. 5, such means includes a pattern storage module 540, and a communications module 550. The pattern storage module 540 stores the patterns identified by the analysis module 530. The number of stored patterns will depend upon the challenge at hand. In some instances, there might be a couple of patterns for each type of attack. In other instances, there might be many patterns for each type of attack.

The communications module 550 communicates with client devices 560 of front line forces via a communications network 570. Examples of a communications network 570 include, but are not limited to, Single Mobility System (SMS), and single channel radio such as PRC-117. When linked with GPS, the GPS can identify the location of a client device 560, and the system 510 can look at patterns for that location.

The system 510 of FIG. 5 also includes a query module 580, which generates a query and sends the query to an assessment module 590. In some instances, the query may include attribute taken from a mission plan. In other instances, the query may include attributes of the current state of the mission.

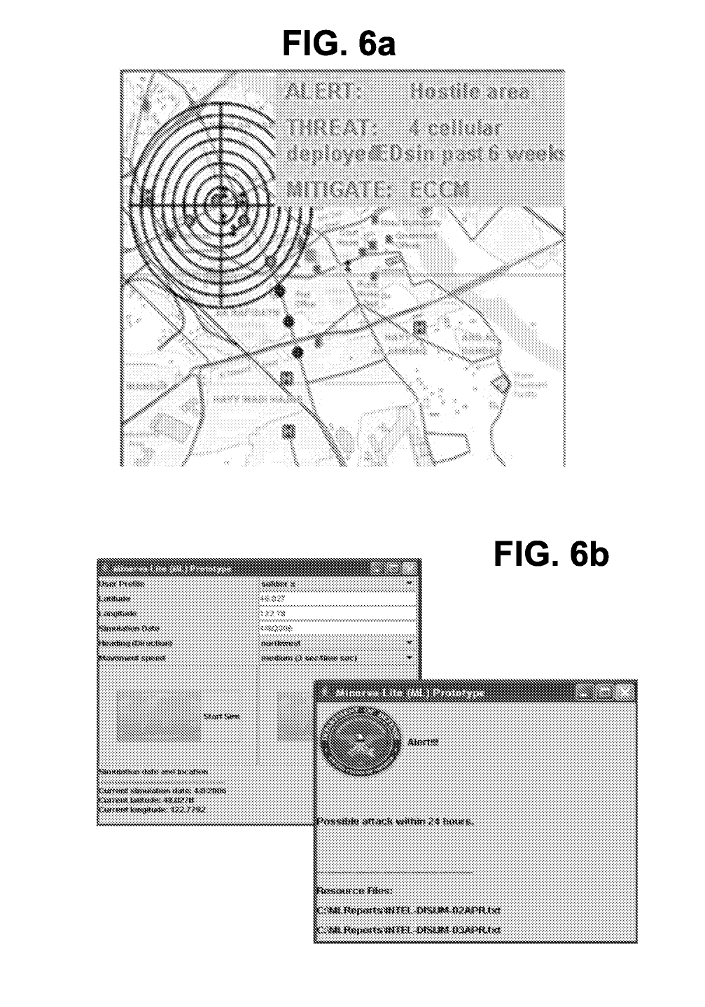

The assessment module 590 receives the queries and uses Autoassociative Memory to return one or more patterns based on the mission plan attributes. The assessment module 590 may also generate an alert and issue the alert to the client devices 560. FIGS. 6a and 6b illustrate some examples of alerts.

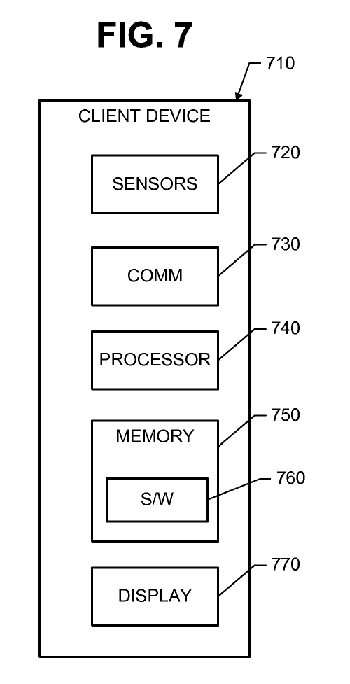

Reference is now made to FIG. 7, which illustrates an example of a client device 710. The client device 710 includes sensors 720, and communications 730 for communicating with a home station. The client device 710 further includes a processor 740 and memory 750 for storing software 760.

Depending on the “intelligence” of the client device 710, the client device 710 could simply send requests to the system 510 of FIG. 5 and display hostility activities information returned by the system 510. A more intelligent device 710 could retrieve patterns from the system 510 and generate its own queries and perform its own assessment based on location and other current information.

The client device 710 further includes a graphics user interface (part of the software 760) and a display 770 for displaying information such as alerts, suggestions to avoid attacks (e.g., alter a plan of operation as critical situations are developing in order to preventively influence the course of events), etc. The graphics user interface also allows observations to be entered.

In another embodiment, patterns may be pre-loaded into a client 710 in a pattern storage module, and the client 710 is provided with an analysis module. This embodiment is advantageous if communications between the client 710 and the home station are not reliable. For instance, a client 770 may include a GPS for updating locations. As new locations are sensed, and as new observations are entered, the client applies Autoassociative Memory to the pre-loaded patterns, given the updated attributes, to predict a mission outcome and/or events during the mission.

1. A method comprising:
identifying a set of mission attributes; and
using a computer to apply Autoassociative Memory to a plurality of patterns to predict at least one of a mission outcome and a future event that, given the set of mission attributes, might occur during execution of a mission.

2. The method of claim 1, further comprising:
forming a plurality of memory entities including matrices of attributes taken from historical data, wherein each matrix corresponds to an instance of an event or outcome, and wherein each matrix correlates the occurrence different attributes within the instance; and
generating the patterns, including applying Heteroassociative Memory to the plurality of memory entities.

3. The method of claim 2, wherein the Heteroassociative Memory analyzes number and quality of connections between the attributes and identifies the strength and correlation of the attributes of similar entities.

4. The method of claim 1, wherein identifying the mission attributes includes formulating a mission plan and identifying the mission attributes from the mission plan.

5. The method of claim 1, wherein identifying the mission attributes includes updating the mission attributes during an operational phase of a mission.

6. The method of claim 1, further comprising raising an alert if a likelihood of failure or a likelihood of a hostile event is predicted.

7. The method of claim 1, further comprising communicating the patterns to front line forces, wherein the patterns are evaluated by the front line forces during execution of the mission.

8. The method of claim 1, further comprising communicating the predictions to front line forces.

9. The method of claim 1, wherein the event is a weapon attacks.

10. A method comprising processing historical data to predict at least one of an event and an outcome of a mission in an environment, including:
forming a plurality of memory entities including matrices of attributes taken from historical data about the environment, wherein each matrix corresponds to an instance of an event or outcome, and wherein each matrix correlates the occurrence different attributes within the instance; and
applying Heteroassociative Memory to the plurality of memory entities to identify patterns of the attributes.

11. The method of claim 10, wherein the Heteroassociative Memory analyzes number and quality of connections between the attributes and identifies the strength and correlation of the attributes of similar entities.

12. The method of claim 10, further comprising adding lessons learned as attributes of the matrices.

13. The method of claim 10, further comprising collecting the historical data, including parsing intelligence reports and storing parsed terms as the memory entities.

14. A computer system comprising a module for applying Autoassociative Memory to a plurality of patterns to predict at least one of a mission outcome and a future event that, given a set of mission attributes, might occur during execution of a mission.

15. The system of claim 14, wherein the attributes are taken from a mission plan.

16. The system of claim 14, further comprising a second module for:
forming a plurality of memory entities including matrices of attributes taken from historical data, wherein each matrix corresponds to an instance of an event or outcome, and wherein each matrix correlates the occurrence of different attributes within the instance; and
generating the patterns, including applying Heteroassociative Memory to the plurality of memory entities.

17. The system of claim 16, wherein the second module is programmed to communicate with various sources to collect intelligence reports and other information about a geographic region of interest; and store the reports as the memory entities.

18. The system of claim 14, further comprising a module for communicating with a plurality of client devices to provide at least one of a predicted mission outcome and event.

19. The system of claim 14, further comprising a second module for communicating with a home station to download the patterns.

20. The system of claim 14, further comprising a module for displaying alerts in response to the predictions.
